(19) United States
(12) Patent Application Publication
(10) Pub. No.: US 2012/0199779 A1
(43) Pub. Date: Aug. 9, 2012

(54) VALVE BLOCK ASSEMBLY FOR A BLOW MOLDING SYSTEM

(75) Inventor: Christian Elbs, Ennetbuhl (CH)

(73) Assignee: Norgren GmbH, Alphen (DE)

(21) Appl. No.: 13/499,942

(22) PCT Filed: Oct. 7, 2010
(86) PCT No.: PCT/EP2010/006130

§ 371 Date: Apr. 3, 2012

Related U.S. Application Data
(60) Provisional application No. 61/250,122, filed on Oct. 9, 2009.

(51) Int. Cl. F16K 1/00; B21D 51/16

(52) U.S. Cl. 251/324; 29/890.12

(57) ABSTRACT

A valve block assembly (300) for a blow molding system is provided. The valve block assembly (300) comprises a valve block housing (301) and a stretch rod (303) movable along a longitudinal axis (324) within a stretch rod bore (304) formed in the valve block housing (301). The valve block assembly (300) also includes one or more valves (302a) coupled to the valve block housing (301) and spaced away from the stretch rod (303). Each of the one or more valves (302a) includes a valve piston (323) with a longitudinal axis (325) substantially parallel to the longitudinal axis (324) of the stretch rod (303).

### TECHNICAL FIELD

The present invention relates to, blow molding systems, and more particularly, to a valve block assembly for a blow molding system with an improved flow path.

### BACKGROUND OF THE INVENTION

Blow molding is a generally known process for molding a preform part into a desired product. The preform is in the general shape of a tube with an opening at one end for the introduction of pressurized gas, typically air; however, other gases may be used. One specific type of blow molding is stretch blow molding (SBM). In SBM applications, a valve block provides both low and high-pressure gas to expand the preform into a mold cavity. The mold cavity comprises the outer shape of the desired product. SBM can be used in a wide variety of applications; however, one of the most widely used applications is in the production of Polyethylene terephthalate (PET) products, such as drinking bottles. Typically, the SBM process uses a low-pressure supply along with a stretch rod that is inserted into the preform to stretch the preform in a longitudinal direction and radially outward and then uses a high-pressure supply to expand the preform into the mold cavity. The low-pressure and high-pressure supply can be controlled using a blow molding valve. The resulting product is generally hollow with an exterior shape conforming to the shape of the mold cavity. The gas in the preform is then exhausted through one or more exhaust valves. This process is repeated during each blow molding cycle.

As can be appreciated, with the high speed of the molding cycle that is currently achievable, even small losses in energy during each molding cycle can result in substantial increases in operating costs. One of the major costs associated with stretch blow molding systems is the compressed gas used to expand the preform. The amount of gas required and the amount of energy required to pressurize the gas can be significant. Therefore, decreasing the amount of gas required during each molding cycle as well as minimizing the pressure drop of the gas through the system can substantially reduce the cost required to expand the preform.

Prior art systems have attempted to limit the loss of pressurized gas by forming valve blocks around the stretch rod. These prior art systems attempt to position the valves closer to the stretch rod and thus, the preform, in order to minimize the distance the pressurized gas is required to travel. While these prior art systems position the valve closer to the preform, the pressurized gas is required to travel along a fluid flow path that typically includes four or more right angle turns. Each turn has an associated pressure drop. As a result, a much higher pressure is required to be delivered to the valve block than is eventually delivered to the preform. This increase in pressure results in higher operating costs. In addition, the valve block is generally formed from a single component. As a result, the flow path is difficult to form. Often the flow path is formed by drilling the gas bores, which results in the rough right angle turns.

The present invention overcomes this and other problems and an advance in the art is achieved. The present invention replaces the prior art valve block with a valve block having an optimized flow path that reduces the number of turns the compressed gas is required to travel. Furthermore, the valve block is separated into two or more slices that allow the flow path to be chamfered around the edges. As a result, not only does the valve block of the present invention reduce the associated pressure drop, but also shortens the fluid flow path resulting in less compressed gas lost during the exhausting phase of the molding cycle.

### SUMMARY OF THE INVENTION

A valve block assembly for a blow molding system is provided according to an embodiment of the invention. The valve block assembly comprises a valve block housing and a stretch rod movable along a longitudinal axis within a stretch rod bore formed in the valve block housing. The valve block assembly also includes one or more valves that are coupled to the valve block housing and spaced away from the stretch rod. According to an embodiment of the invention, each of the one or move valves includes a valve piston with a longitudinal axis substantially parallel to the longitudinal axis of the stretch rod.

A valve block assembly for a blow molding system is provided according to another embodiment of the invention. The valve block assembly comprises a valve block housing and a stretch rod bore formed in the valve block housing. A stretch rod is provided that is movable along a longitudinal axis within a stretch rod bore formed in the valve block housing. According to an embodiment of the invention, one or more fluid flow paths are provided. Each fluid flow path is defined by one or more pressurized gas ports formed in the valve block housing and a first fluid conduit coupled to each of the one or more pressurized gas ports, the first fluid conduit having a longitudinal axis substantially parallel to the longitudinal axis of the stretch rod. The fluid flow path is also defined by a second fluid conduit coupled to the first fluid conduit and to the stretch rod bore, the second fluid conduit having a longitudinal axis substantially perpendicular to the longitudinal axis of the stretch rod and to the longitudinal axis of the first fluid conduit. According to an embodiment of the invention, the fluid flow path is also defined by a valve coupled to the second fluid conduit and adapted to selectively open a fluid flow path between the first fluid conduit and the second fluid conduit.

A valve block assembly is provided according to another embodiment of the invention. The valve block assembly includes two or more valve housing portions that are coupled to form a valve block housing. The valve block assembly also includes a stretch rod bore formed in the two or more valve housing portions and a stretch rod movable along a longitudinal axis within the stretch rod bore. One or more fluid flow paths are provided in the valve block assembly. Each of the one or more fluid flow paths are defined by a fluid port formed in a first valve housing portion and a first fluid channel portion formed in the first valve housing portion. The first fluid channel portion is in fluid communication with the fluid port and has a longitudinal axis substantially parallel to the longitudinal axis of the stretch rod. The fluid flow path is further defined by a second fluid channel portion formed in the first valve housing portion and a second valve housing portion such that the first and second fluid channel portions intersect one another. The second fluid channel portion is in fluid communication with the first fluid channel portion and the stretch rod bore. The second fluid channel portion has a longitudinal axis substantially perpendicular to the longitudinal axis of the stretch rod and to the longitudinal axis of the first fluid channel portion. The fluid flow path is further defined by a valve located in the second valve housing portion proximate the intersection of the first and second fluid channel portions. The valve is adapted to selectively open a fluid flow path between the first fluid channel portion and the second fluid channel portion.

A method for forming a valve block assembly for a blow molding system is provided according to an embodiment of the invention. The method comprises the step of positioning a stretch rod within a stretch rod bore formed in a valve block housing such that the stretch rod is movable along a longitudinal axis within the stretch rod bore. The method also comprises the step of coupling one or more valves to the valve block housing with the one or more valves spaced away from the stretch rod such that a longitudinal axis of a valve piston of each of the one or more valves is substantially parallel to a longitudinal axis of the stretch rod.

### ASPECTS

According to an aspect of the invention, a valve block assembly for a blow molding system comprises:
a valve block housing;
a stretch rod movable along a longitudinal axis within a stretch rod bore formed in the valve block housing; and
one or more valves coupled to the valve block housing and spaced away from the stretch rod;
wherein each of the one or move valves includes a valve piston with a longitudinal axis substantially parallel to the longitudinal axis of the stretch rod.

Preferably, the valve block assembly further comprises one or more fluid flow paths, with each flow path being defined by:
a pressurized gas port;
a first fluid conduit coupled to the pressurized gas port;
a second fluid conduit coupled to the first fluid conduit and the stretch rod bore; and
a valve of the one or more valves coupled to the second fluid conduit proximate the first fluid conduit.

Preferably, the fluid flow path comprises only two changes in direction with a first change in direction proximate the coupling between the first fluid conduit and the second fluid conduit and a second change in direction proximate the coupling between the second fluid conduit and the stretch rod bore.

Preferably, the valve block assembly further comprises a valve seat formed in the second fluid conduit and adapted to form a fluid tight seal with the valve piston.

Preferably, the second fluid conduit comprises a longitudinal axis substantially perpendicular to the stretch rod longitudinal axis and the valve piston longitudinal axis.

Preferably, the valve block assembly further comprises a fluid passageway formed between the stretch rod and the stretch rod bore.

According to another aspect of the invention, a valve block assembly for a blow molding system comprises:
a valve block housing;
a stretch rod bore formed in the valve block housing;
a stretch rod movable along a longitudinal axis within a stretch rod bore formed in the valve block housing;
one or more fluid flow paths with each fluid flow path being defined by:
   a pressurized gas port formed in the valve block housing;
   a first fluid conduit coupled to each of the pressurized gas ports, the first fluid conduit having a longitudinal axis substantially parallel to the longitudinal axis of the stretch rod;
   a second fluid conduit coupled to the first fluid conduit and to the stretch rod bore, the second fluid conduit having a longitudinal axis substantially perpendicular to the longitudinal axis of the stretch rod and to the longitudinal axis of the first fluid conduit; and
   a valve coupled to the second fluid conduit and adapted to selectively open a fluid flow path between the first fluid conduit and the second fluid conduit.

Preferably, the valve comprises a valve piston movable along a longitudinal axis that is substantially parallel to the longitudinal axis of the stretch rod.

Preferably, the fluid flow path comprises only two changes in direction with a first change in direction proximate the coupling between the first fluid conduit and the second fluid conduit and a second change in direction proximate the coupling between the second fluid conduit and the stretch rod bore.

Preferably, the valve block assembly further comprises a valve seat formed in the second fluid conduit and adapted to form a fluid tight seal with the valve piston.

Preferably, the valve block assembly further comprises a fluid passageway between the stretch rod and the stretch rod bore.

According to another aspect of the invention, a valve block assembly comprises:
two or more valve housing portion coupled together to form a valve block housing;
a stretch rod bore formed in the two or more valve housing portions;
a stretch rod movable along a longitudinal axis within the stretch rod bore;
one or more fluid flow paths with each fluid flow path being defined by:
   a fluid port formed in a first valve housing portion;
   a first fluid channel portion formed in the first valve housing portion and in fluid communication with the fluid port, the first fluid channel portion having a longitudinal axis substantially parallel to the longitudinal axis of the stretch rod;
   a second fluid channel portion formed in the first valve housing portion and a second valve housing portion such that the first and second fluid channel portions intersect one another and wherein the second fluid channel portion is in fluid communication with the first fluid channel portion and the stretch rod bore, the second fluid channel portion having a longitudinal axis substantially perpendicular to the longitudinal axis of the stretch rod and to the longitudinal axis of the first fluid channel portion; and
   a valve located in the second valve housing portion proximate the intersection of the first and second fluid channel portions and adapted to selectively open a fluid flow path between the first fluid channel portion and the second fluid channel portion.

Preferably, the valve block assembly further comprises a first turn proximate the intersection of the first fluid channel portion and the second fluid channel portion and comprising a chamfered corner formed in the first valve housing portion.

Preferably, the valve block assembly further comprises a second turn between the second fluid channel portion and the stretch rod bore defined by a chamfered corner formed in the second valve housing portion.

Preferably, the valve comprises a valve piston movable along a longitudinal axis that is substantially parallel to the longitudinal axis of the stretch rod.

According to another aspect of the invention, a method for forming a valve block assembly for a blow molding system comprises the steps of:
positioning a stretch rod within a stretch rod bore formed in a valve block housing such that the stretch rod is movable along a longitudinal axis within the stretch rod bore; and
positioning one or more valves at least partially within the valve block housing with the one or more valves spaced away from the stretch rod such that a longitudinal axis of a valve piston of each of the one or more valves is substantially parallel to a longitudinal axis of the stretch rod.

Preferably, the method further comprises the step of forming one or more fluid flow paths with each fluid flow path being formed by:
coupling a first fluid conduit to a port formed in the valve block housing;
coupling a second fluid conduit to the first fluid conduit and to the stretch rod bore; and
coupling a valve of the one or more valves to the second fluid conduit proximate the first fluid conduit.

Preferably, the first fluid conduit comprises a longitudinal axis that is substantially parallel to the longitudinal axis of the stretch rod and wherein the second fluid conduit comprises a longitudinal axis that is substantially perpendicular to the longitudinal axis of the stretch rod.

Preferably, the fluid flow path comprises only two changes in direction with a first change in direction proximate the coupling between the first fluid conduit and the second fluid conduit and a second change in direction proximate the coupling between the second fluid conduit and the stretch rod bore.

Preferably, the valve is coupled to the second fluid conduit such that a valve piston of the valve can engage a valve seat formed in the second fluid conduit.

Preferably, wherein the valve block housing comprises two or more valve housing portions and wherein the method further comprises the step of forming one or more fluid flow paths with each fluid flow path being formed by:
forming a fluid port and a first fluid channel portion in fluid communication with the fluid port in a first valve housing portion;
forming a second fluid channel portion in the first valve portion and a second valve portion such that the second fluid channel portion intersects the first fluid channel portion and is in fluid communication with the first fluid channel portion and the stretch rod bore;
positioning a valve of the one or more valves in the second block housing portion proximate the intersection of the first and second fluid channel portions; and
coupling the first and second valve housing portions together.

Preferably, the fluid flow path comprises only two changes in direction with a first change in direction proximate the intersection of the first and second fluid channel portions and comprising a first chamfered corner and a second change in direction between the second fluid channel portion and the stretch rod bore and comprising a second chamfered corner.

### BRIEF DESCRIPTION OF THE DRAWINGS

FIG. 1 shows a cross sectional view of a portion of the prior art valve block assembly.

FIG. 2 shows a valve block assembly for a blow molding system according to an embodiment of the invention.

FIG. 3 shows an enlarged view of detail 400 shown in FIG. 2.

FIG. 4 shows a cross sectional view of a portion of the valve block assembly according to an embodiment of the invention.

FIG. 5 shows a cross sectional view of a portion of the valve block assembly according to another embodiment of the invention.

### DETAILED DESCRIPTION OF THE INVENTION

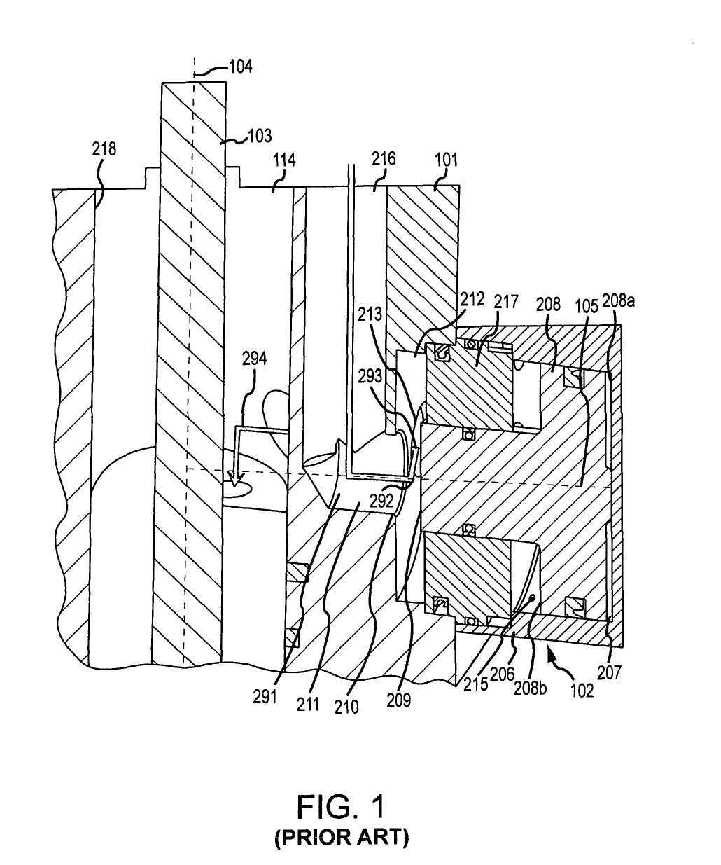

FIGS. 1-5 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 shows a cross-sectional view of a portion of a prior art valve block assembly 100. The valve block assembly 100 includes a valve block housing 101, a valve 102 coupled to the valve block housing 101, and a stretch rod 103. While only one valve 102 is shown, it should be appreciated that the valve block assembly 100 may include more than one valve. The stretch rod 103 comprises an elongated rod with a longitudinal axis 104. The stretch rod 103 extends through a stretch rod bore 114 along the longitudinal axis 104 and contacts the preform when extended, as is generally known in the art.

Each valve 102 is configured to control the flow of pressurized gas into the preform in order to mold the preform or exhaust gas out of the preform at the end of the molding cycle. In order to control the flow of pressurized gas, each valve 102 includes a movable valve piston 208. As shown in FIG. 1, by the broken line 105, each valve piston 208 moves in a direction substantially perpendicular to the longitudinal axis 104 of the stretch rod 103. While this orientation is widely used in prior art blow molding valve block assemblies, this orientation does not provide an ideal flow path for the pressurized gas to travel.

As can be seen, the valve 102 is coupled to the valve block housing 101. The valve 102d includes a valve housing 206, a control chamber 207 formed in the valve housing 206 and a valve piston 208 movable within a control chamber 207. The position of the valve piston 208 is controlled by supplying a pilot pressure to the control chamber 207. The pilot pressure may be supplied through a port (not shown) formed in the control chamber 207, for example. The valve piston 208 includes a valve-sealing portion 209 that is adapted to seal against a valve seat 210. The valve 102 can also include a guide 217 that can ensure proper orientation of the valve piston 208, and more specifically, the valve-sealing portion 209 relative to the valve seat 210. The valve seat 210 is located around a first fluid port 211, which is formed in a process air chamber 212 of the valve block housing 101. The valve piston 208 is adapted to seal against the valve seat 210 to selectively allow fluid to flow from the first fluid port 211, into the process air chamber 212, and into a second fluid port 213. The second fluid port 213 is also formed in the process air chamber 212. The second fluid port 213 is in fluid communication with the process air chamber 212 as well as the passageway 214, which is formed between the stretch rod 103 and the stretch rod bore 218 formed in the valve block housing 101. The size of the passageway 214 is exaggerated for the purpose of illustration, and in actuality, the passageway 214 may be much smaller.

In use, when the control chamber 207 is pressurized by a pilot pressure, the pressure acts on a first side 208a of the valve piston 208. As a result, the valve piston 208 moves to the left as shown in the figure. As the valve piston 208 moves to the left, gas exposed to the second side 208b may be vented through a vent port 215 formed in the control chamber 207. The valve piston 208 will move to the left until the valve-sealing portion 209 contacts the valve seat 210.

Conversely, when the control chamber 207 is exhausted, the pressurized process air supplied to the first fluid port 211 biases the valve piston 208 away from the valve seat 210. As a result, fluid is allowed to flow from the first fluid port 211 into the process air chamber 212. The process air may enter the valve block housing 101 through an opening (not shown) formed in the valve housing 101. A fluid conduit 216 provides a fluid communication path between the opening and the first fluid port 211. As can be seen, due to the orientation of the valve 102, and more particularly, the orientation of the valve piston 208, the process air is required to make a first ninety-degree turn 291 in order to enter the process air chamber 212. Further, because the valve housing 101 is formed from as a single component, the fluid conduit 216 is formed by drilling. This results in a sharp corner 281 at the first ninety-degree turn 291. As is generally known in the art, sharp corner turns can produce a significant head loss as the fluid separates from the wall of the conduit. Once the process air enters the process air chamber 212, the process air is required to make a second ninety-degree turn 292 in order to travel towards the second fluid port 213. Once the process air reaches the second fluid port 213, a third ninety-degree turn 293 is required for the process air to enter the second fluid port 213. The process air travels within the second fluid port 213 and enters the passageway 214 formed between the stretch rod 103 and the valve block housing 101. Upon entering the passageway 214, the process air makes a fourth ninety-degree turn 294 in order to flow towards the preform to expand the preform into the mold cavity as is generally known in the art.

As can be appreciated, with each ninety-degree turn, the pressure of the process air drops. This pressure drop is amplified by the sharp corners at each turn. Therefore, because the prior art valve block assembly 100 requires four ninety-degree turns between entering the valve block assembly 100 and reaching the preform, there can be a substantial pressure drop. While the particular prior art valve block assembly 100 requires four ninety-degree turns, other prior art valve blocks require more than four ninety-degree turns. As a result, the pressure of the process air entering the valve block assembly 100 is required to be substantially higher than the process air pressure that eventually reaches the preform. This is because the pressure applied to the preform is typically required to be at a predetermined pressure. As can be appreciated, the energy required to pressurize the process air increases as the required pressure increases. Because of the large number of molding cycles that take place over a given period, this increased pressure can lead to a substantial increase in the cost of producing the desired blow molded product.

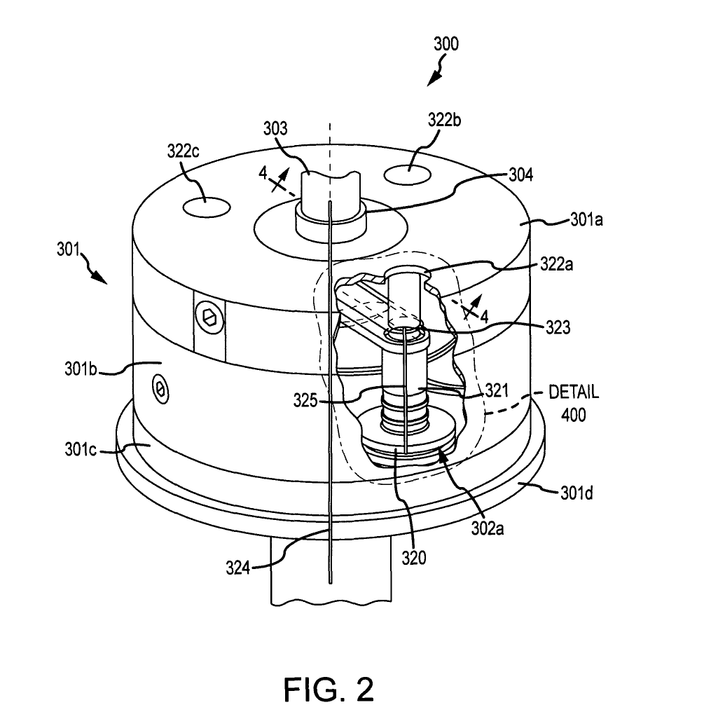

FIG. 2 shows a blow molding valve block assembly 300 according to an embodiment of the invention. The blow molding valve block assembly 300 may be incorporated into a larger blow molding system (not shown). The blow molding valve block assembly 300 is similar to the blow molding valve block assembly 100, except for the blow molding valves used in the valve block assembly 300 and the associated fluid flow path the pressurized fluid travels. Furthermore, the housing can be separated into a plurality of sections, which will be described further below. The pressurized fluid may comprise a pressurized gas, liquid, or a mixture thereof. Typically, the pressurized fluid will comprise pressurized air and therefore, the discussion that follows is directed towards a pressurized gas. According to an embodiment of the invention, the blow molding valve block assembly 300 includes a valve block housing 301, one or more valves 302a positioned at least partially within the valve block housing 301, and a stretch rod 303 movable within a stretch rod bore 304 formed in the valve block housing 301. The position of the stretch rod 303 may be controlled using an external component (not shown). According to some embodiments, the one or more valves 302a may be coupled to the valve block housing 301. While only one valve 302 is visible, it should be appreciated that the blow molding valve block assembly 300 may include any number of desired valves. According to an embodiment of the invention, the valve block housing 301 comprises two or more portions 301a-301d. While only four portions 301a-301d are shown in the present embodiment, it should be appreciated that the valve block housing 301 may comprise more or less than four portions. As shown, each of the four portions 301a-301d shown comprise a substantially disc shaped portion. The four portions 301a-301d can be stacked together along a longitudinal axis 324 of the stretch rod 303. The valve block portions 301a-301c may be coupled together according to a variety of methods including, welding, bonding, brazing, mechanical fasteners, etc. Therefore, the particular method used to couple the two or more valve block portions 301a-301d together should not limit the scope of the present invention. Some of the advantages to providing a valve block housing 301 in four or more portions 301a-301d rather than forming the valve block housing from a single block as in the prior art will be discussed in more detail below.

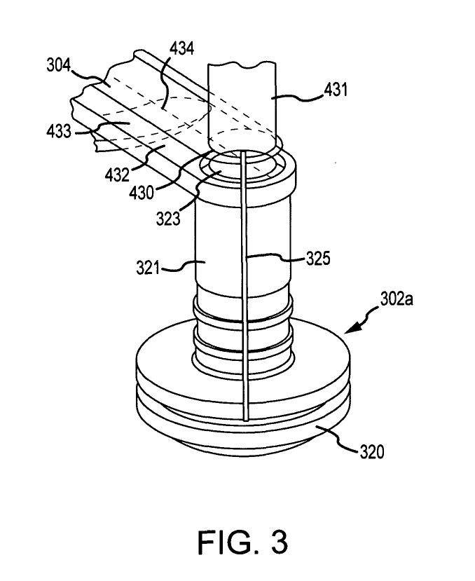

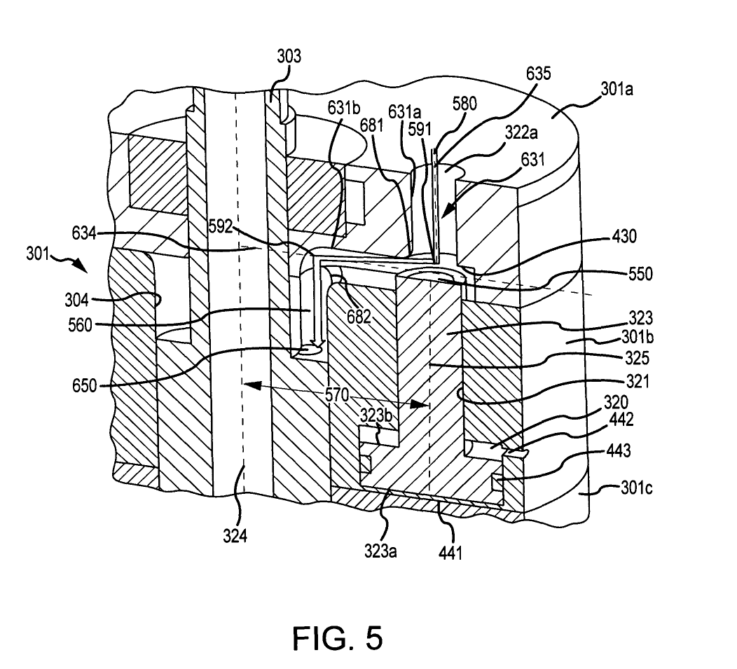

According to an embodiment of the invention, the one or more valves 302a may be positioned at least partially within the valve block housing 301. While only the valve 302a is visible inside the valve block housing 301, it should be appreciated that the other valves 302b-302c are similarly situated within the valve block housing 301 and include similar components. Therefore, the discussion below is limited to the valve 302a in the interest of brevity of the description. As can be seen through the cut-away in the valve block housing 301, the valve 302a comprises an enlarged portion, which forms a control chamber 320. The control chamber 320 can be coupled to a third portion 301c of the valve block housing 301. In some embodiments, the control chamber 320 is formed in the third portion 301c (See FIG. 5). The control chamber 320 will be described in more detail in FIGS. 3 & 4. The valve 302a also includes a piston sleeve 321. The piston sleeve 321 can be provided to guide a valve piston 323 as will be described further below. The valve piston 323 can selectively open and close a fluid flow path between a port 322a formed in a first portion 301a of the valve block housing 301 and the stretch rod bore 304. As can be appreciated, each valve 302a includes an associated port 322a-322c. The ports 322a-322c may comprise inlet ports or exhaust ports depending on the intended use of the associated valve 302a. According to the embodiment shown, the piston sleeve 321 is substantially parallel to and spaced away from the stretch rod 303 and the stretch rod bore 304. The parallel orientation of the valve 302a provides a more direct flow path from the port 322a to the stretch rod bore 304 as will be described further below.

FIG. 3 shows an enlarged view of detail 400 shown in FIG. 2. As can be seen more clearly in FIG. 3, the valve 302a includes a valve piston 323 that is movable within the control chamber 320 and the piston sleeve 321. The valve piston 323 selectively engages a valve seat 430, which is shown in ghost lines in FIG. 3. According to an embodiment of the invention, the valve seat 430 is provided in a second fluid conduit 432. The second fluid conduit 432 can couple the first fluid conduit 431 to the piston sleeve 321. According to an embodiment of the invention, the first fluid conduit 431 communicates pressurized gas from the port 322a to the second fluid conduit 432. The second fluid conduit 432 is also coupled to the stretch rod bore 304. Therefore, the second fluid conduit 432 provides a fluid flow path for the pressurized gas to travel from the port 322a to the stretch rod bore 304 as will be described in more detail below.

According to an embodiment of the invention, the second fluid conduit 432 can form a substantially fluid tight seal with the piston sleeve 321. According to an embodiment of the invention, the second fluid conduit 432 can also form a substantially fluid tight seal with the first fluid conduit 431. Additionally, the second fluid conduit 432 can form a substantially fluid tight seal with a process gas port 433 formed in the stretch rod bore 304. According to an embodiment of the invention, the second fluid conduit 432 includes a longitudinal axis 434. The longitudinal axis 434 of the second fluid conduit 432 is approximately perpendicular to the valve piston's longitudinal axis 325 and the stretch rod's longitudinal axis 324.

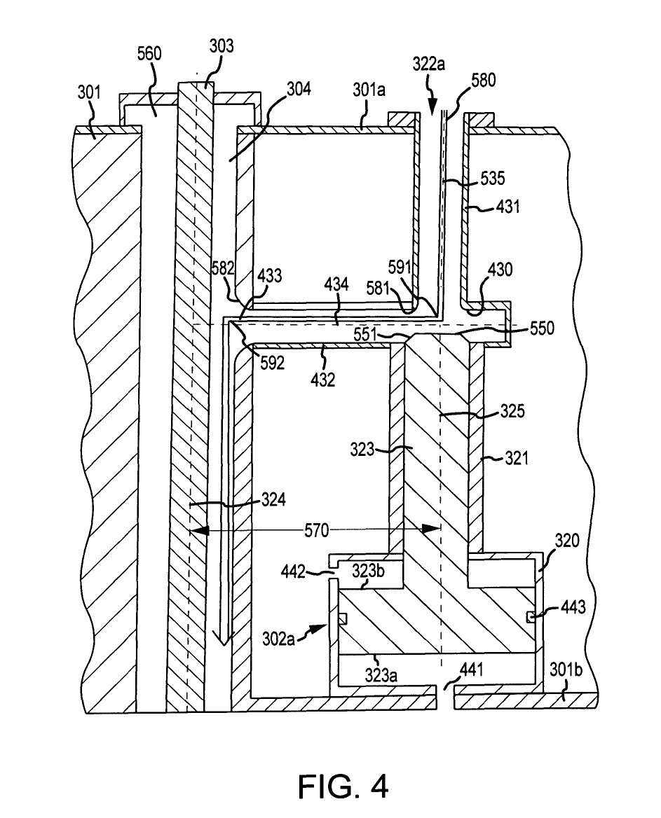

FIG. 4 shows a cross-sectional view of a portion of the valve block assembly 300 taken along line 4-4 of FIG. 2. It should be appreciated that only a portion of the valve block assembly 300 taken along line 4-4 is shown in order to simplify the drawing. According to an embodiment of the invention, the valve 302a can be coupled to the valve block housing 301. More specifically, the valve 302a is shown coupled to the bottom surface 301b of the valve block housing 301. According to the embodiment shown in FIG. 4, the valve 302a is positioned such that the valve piston 323 is spaced away from the stretch rod 303 by a distance 570. Furthermore, the valve piston 323 comprises a longitudinal axis 325 that is spaced away from and substantially parallel to the longitudinal axis 324 of the stretch rod 303. By spacing the valve 302a away from the stretch rod 303 by the distance 570 rather than providing a ring shaped piston that surrounds the stretch rod 303 in a coaxial arrangement as in some prior art designs that include multiple valves surrounding the stretch rod 303 and stacked upon one another, an individual valve may be removed or replaced without disrupting the remaining valves. Advantageously, maintenance of the valve block assembly 300 is made easier than in the prior art. It should be appreciated that the remaining valves included in the valve block assembly 300 are similarly situated around the longitudinal axis of the stretch rod 303. It should also be appreciated that the movement of the valve piston 323 as is described in more detail below is in a direction substantially parallel to the longitudinal axis of the stretch rod 303. The orientation of the valve piston 323 creates a much simpler flow path for the pressurized gas to travel through the valve block assembly 300 than in the prior art. Advantageously, the pressure drop realized in the valve block assembly 300 is much less than in the prior art valve block 100.

As can be seen in FIG. 4, the valve piston 323 is movable within the control chamber 320 and the piston sleeve 321. The piston sleeve 321 is shown coupled to and extending from the control chamber 320. The control chamber 320 may include a control pressure port 441. The control pressure port 441 may be in fluid communication with a control pressure, such as a pilot pressure from a pilot valve (not shown). The control chamber 320 can also include a vent port 442. The vent port 442 can be provided to prevent a vacuum from being created as the valve piston 323 moves within the control chamber 320. According to an embodiment of the invention, the valve piston 323 can include a sealing member 443. The sealing member 443 may comprise an O-ring sealing member, or some other type of sealing member, such as a K-ring, for example. Those skilled in the art will readily recognize alternative sealing members that may be used. Therefore, the particular sealing member used should not limit the scope of the present invention. The sealing member 443 can be provided to form a fluid tight seal between the valve piston 323 and the control chamber 320.

According to an embodiment of the invention, the valve piston 323 includes a first side 323a and a second side 323b. In the embodiment shown, the first side 323a is exposed to the control pressure port 441 while the second side 323b is exposed to the vent port 442. When a control pressure is supplied through the control pressure port 441, the control pressure acts on the first side 323a of the valve piston 323 to bias the valve piston 323 in a first direction. As the valve piston 323 is biased in the first direction, pressure exposed to the second side 323b of the valve piston 323 can vent through the vent port 442. According to an embodiment of the invention, the first direction is towards the valve seat 430. As a result, when a control pressure is provided to the control pressure port 441, the valve piston 323 can move within the control chamber 320 as well as the valve piston sleeve 321 towards the valve seat 430. The valve piston 323 can include a sealing surface 550 that is adapted to engage the valve seat 430 formed on the second fluid conduit 432. Upon engaging the valve seat 430, the sealing surface 550 of the valve piston 323 forms a substantially fluid tight seal with the valve seat 430. Therefore, fluid is prevented from flowing from the fluid port 322a to the stretch rod bore 304.

Upon exhausting of the control chamber 320 to at least a threshold pressure, the pressurized gas in the first fluid conduit 431 can bias the valve piston 323 in a second direction, which is substantially opposite the first direction. If the valve 302a is used to exhaust pressure in the preform rather than providing fluid to the preform, the pressure in the stretch rod bore 304 and in the second fluid conduit 432 can act on the beveled surface 551 formed on the valve piston 323 to bias the valve piston 323 in the second direction once the pressure in the control chamber 320 is exhausted to below a threshold level. However, the discussion below assumes the valve 302a is used for supplying pressurized gas to the preform. As the valve piston 323 moves in the second direction, the valve piston 323 unseats from the valve seat 430. The valve piston 323 is shown unseated from the valve seat 430 in FIG. 4. With the valve piston 323 moved away from the valve seat 430, pressurized gas is free to flow from the port 322a to the stretch rod bore 304. More specifically, the pressurized gas is free to flow from the port 322a to a passageway 560 formed between the stretch rod 303 and the stretch rod bore 304. The size of the passageway 560 is shown enlarged for the purpose of illustration and, in actuality, the passageway 560 may be much smaller.

According to an embodiment of the invention, the valve block assembly 300 comprises a fluid flow path 580 with only two changes in direction between the port 322a and the passageway 560. According to an embodiment of the invention, pressurized gas can enter the fluid port 322a and travel along a flow path 580 through the first fluid conduit 431 towards the second fluid conduit 432 and the valve piston 323. As can be seen, the first fluid conduit 431 comprises a longitudinal axis 535. The first fluid conduit 431 is coupled to the port 322a and the second fluid conduit 432 such that the longitudinal axis 535 is substantially parallel to the longitudinal axis 324 of the stretch rod 303. Once the pressurized gas is proximate the coupling between the first fluid conduit 431 and the second fluid conduit 432, the pressurized gas encounters a first change in direction and makes a first turn 591 towards the stretch rod bore 304. According to an embodiment of the invention, the coupling between the first fluid conduit 431 and the second fluid conduit 432 comprises a chamfered corner 581 rather than the sharp corner 281 in the prior art valve block 100. As can be appreciated that chamfered corner 581 reduces the fluid separation from the conduits 431, 432 resulting in less of a pressure drop. According to an embodiment of the invention, the first turn 591 is required because the longitudinal axes 535 and 434 are substantially perpendicular to one another. Upon reaching the stretch rod bore 304, the pressurized gas can flow through the process gas port 433 into the stretch rod bore 304. With the process gas proximate the coupling between the second fluid conduit 432 and the stretch rod bore 304, the process gas reaches a second change in direction and makes a second turn 592 within the passageway 560 between the stretch rod 303 and the stretch rod bore 304 towards the preform (not shown). According to an embodiment of the invention, the second turn 592 also includes a chamfered corner 582. The second turn 592 is required because in the embodiment shown, the longitudinal axes 434 and 324 are substantially perpendicular to one another. According to an embodiment of the invention, the first and second turns 591, 592 comprise approximately ninety-degree turns. However, in other embodiments, the turns 591, 592 may comprise angles greater than or less than ninety-degrees. It should be appreciated however, that the valve block 300 only requires the pressurized gas to change directions twice. As a result, the pressurized gas experiences less of a pressure drop than in the prior art valve blocks that required the pressurized gas to make four or more changes in direction. Furthermore, it should be appreciated that the flow path of the valve block 300 is much shorter than the flow path of the prior art valve block 100. Therefore, the gas lost during exhausting of the preform is much less than the gas lost during the exhausting of the preform using the valve block 100.

FIG. 5 shows a cross sectional view of a portion of the valve block assembly 300 taken along line 4-4 in FIG. 2 according to yet another embodiment of the invention. The embodiment shown in FIG. 5, is similar to the embodiment shown in FIG. 4; however, rather than providing separate fluid conduits 431, 432, that are coupled together to form the fluid flow path 580, the embodiment shown in FIG. 5 includes a fluid channel 631 formed in the valve block housing 301. More specifically, the fluid channel 631 is formed in two or more portions 301a, 301b of the valve block housing 301. Therefore, unlike the valve block 100 where the various fluid channels are formed in a single block, the fluid channel 631 is formed in two or more valve housing portions 301a, 301b. Furthermore, while the fluid channel 631 is shown being formed in only two of the four shown valve housing portions, in other embodiments, the fluid channel 631 may be formed in more than two valve housing portions.

As described above, in some embodiments, the valve block housing 301 can be formed from two or more separate valve housing portions 301a-301d. In the embodiment shown in FIG. 5, the valve block housing 301 comprises four portions 301a-301d. According to an embodiment of the invention, the valve housing portions 301a-301d can be coupled together according to known methods as described above. According to an embodiment of the invention, the fluid channel 631 can be formed in the valve housing portions 301a-301b prior to coupling the valve housing portions 301a-301b together. Advantageously, the fluid channel 631 can be optimized in order to decrease the pressure drop of the pressurized gas flowing through the valve block assembly 300.

According to an embodiment of the invention, the fluid channel 631 comprises a first portion 631 a that directs fluid in a direction substantially parallel to the longitudinal axis 324 of the stretch rod 303. The first fluid channel portion 631a comprises a longitudinal axis 635. According to an embodiment of the invention, the first portion 631a of the fluid channel 631 is formed in the first valve housing portion 301a. According to an embodiment of the invention, the first channel portion 631a is in fluid communication with the fluid port 322a.

According to an embodiment of the invention, the fluid channel 631 also comprises a second portion 631b. The second fluid channel portion 631b can intersect the first fluid channel portion 631a. Therefore, the first and second fluid channel portions 631a, 631b can be in fluid communication with one another. The second portion 631b directs fluid in a direction substantially perpendicular to the longitudinal axis 324 of the stretch rod 303. The second fluid channel portion 631b comprises a longitudinal axis 634. According to an embodiment of the invention, the second portion 631b of the fluid channel 631 is formed in the first valve housing portion 301a and in the second valve housing portion 301b. According to an embodiment of the invention, the second fluid channel portion 631b intersects the stretch rod bore 304. According to an embodiment of the invention, the stretch rod 303 includes an aperture 650. According to an embodiment of the invention, the aperture 650 can be provided instead of the passageway 560 formed between the stretch rod 303 and the stretch rod bore 304. The stretch rod 303 is also shown with a fluid channel 651, which may be provided to adjust the position of the stretch rod 303 as is generally known in the art.

According to an embodiment of the invention, the valve 302a is positioned proximate the intersection of the first and second fluid channel portions 631a, 631b. According to an embodiment of the invention, the valve 302a is movable within a control chamber 320. The control chamber 320 is shown formed in the second valve housing portion 301b. The valve piston 323 of the valve 302a is movable along a longitudinal axis 325 in a similar manner as described above. Rather than providing a separate piston sleeve 321, the embodiment shown in FIG. 5 comprises a piston sleeve 621 formed in the second valve housing portion 301b.

According to an embodiment of the invention, the fluid channel 631 provides the flow path 580. Similar to the embodiment described in FIG. 4 the flow path 580 provided by the fluid channel 631 comprises two turns resulting in two changes in fluid direction. The fluid flow through the channel 631 is similar to the flow through the fluid conduits 431, 432 described above. For example, the first turn 591 is proximate the intersection of the first fluid channel portion 631a and the second fluid channel portion 631b. With the intersection of the two fluid channel portions 631a, 631b being formed by the first and second valve housing portions 301a, 301b rather than a single valve block, the first turn 591 can comprise a chamfered corner 681. As with the chamfered corner 581, the chamfered corner 681 can substantially reduce the pressure drop created as the fluid flow encounters the first turn 591. The chamfered corner 681 was not readily achievable in the valve block 100 because the flow path is formed by drilling into a single valve housing 101. In contrast, with the first portion 301a separated from the second portion 301b, the chamfered corner 681 can be easily manufactured.

Similarly, with the first valve housing portion 301a and the second valve housing portion 301b separated, a chamfered corner 682 can easily be manufactured at the second turn 592. As a result, the flow path 580 formed by the fluid channel 631 not only comprises two turns 591, 592, but also each turn comprises a chamfered corner 681, 682 thereby reducing the pressure drop through the valve block assembly 300.

According to an embodiment of the invention, the control pressure port 441 may be formed in the second, third, and fourth valve block housing portions 301b-301d. According to an embodiment of the invention, the control pressure port 441 may be formed in each of the valve housing portions 301b-301d prior to coupling the valve housing portions 301b-301d together.

The present invention as described above provides a valve block assembly for a blow molding system with an improved flow path. The flow path is improved due to a number of novel features. According to the embodiments described, the flow of pressurized gas, which may comprise air or some other pressurized gas, can be controlled using one or more valves 302a that are positioned within the valve block housing 301. In contrast to many prior art designs, the valves 302a are arranged such that the valve piston 323 moves in a direction substantially parallel to the longitudinal axis of the stretch rod 303. In addition, the valves 302a are spaced away from the stretch rod 303 rather than being stacked upon one another and coaxially aligned with the stretch rod 303. Therefore, maintenance of the valves can be performed much faster than in the prior art. Furthermore, because of the orientation of the valves 302a, the flow path the pressurized gas travels through the valve block assembly 300 is simplified and only requires two changes in direction. As result, the pressure drop through the valve block assembly 300 is much less than in prior art valve block assemblies that require the pressurized gas to change directions four or more times. Furthermore, the turns can comprise chamfered corners to further reduce the pressure drop. In some embodiments, the chamfered corners are made possible by forming the valve block housing from two or more valve housing portions that are coupled together after the fluid channel is formed. Advantageously, for a given required pressure delivered to the preform, the pressure delivered to the valve block assembly 300 can be less than the pressure required to be delivered to prior art valve block assemblies.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other blow molding valve blocks, and not just to the embodiments described above and shown in the accompanying figures. Accordingly, the scope of the invention should be determined from the following claims.

We claim:

1. A valve block assembly (300) for a blow molding system, comprising:
a valve block housing (301);
a stretch rod (303) movable along a longitudinal axis (324) within a stretch rod bore (304) formed in the valve block housing (301); and
one or more valves (302a) coupled to the valve block housing (301) and spaced away from the stretch rod (303);
wherein each of the one or move valves (302a) includes a valve piston (323) with a longitudinal axis (325) substantially parallel to the longitudinal axis (324) of the stretch rod (303).

2. The valve block assembly (300) of claim 1, further comprising one or more fluid flow paths (580), with each flow path being defined by:
a pressurized gas port (322a-322c);
a first fluid conduit (431) coupled to the pressurized gas port (322a-322c);
a second fluid conduit (432) coupled to the first fluid conduit (431) and the stretch rod bore (304); and
a valve (302a) of the one or more valves (302a) coupled to the second fluid conduit (432) proximate the first fluid conduit (431).

3. The valve block assembly (300) of claim 2, wherein the fluid flow path (580) comprises only two changes in direction with a first change in direction proximate the coupling between the first fluid conduit (431) and the second fluid conduit (432) and a second change in direction proximate the coupling between the second fluid conduit (432) and the stretch rod bore (304).

4. The valve block assembly (300) of claim 2, further comprising a valve seat (430) formed in the second fluid conduit (432) and adapted to form a fluid tight seal with the valve piston (323).

5. The valve block assembly (300) of claim 2, wherein the second fluid conduit (431) comprises a longitudinal axis substantially perpendicular to the stretch rod longitudinal axis (324) and the valve piston longitudinal axis (325).

6. The valve block assembly (300) of claim 1, further comprising a fluid passageway (560) formed between the stretch rod (303) and the stretch rod bore (304).

7. A valve block assembly (300) for a blow molding system, comprising:
a valve block housing (301);
a stretch rod bore (304) formed in the valve block housing (301);
a stretch rod (303) movable along a longitudinal axis (324) within a stretch rod bore (304) formed in the valve block housing (301);
one or more fluid flow paths (580) with each fluid flow path being defined by:
a pressurized gas port (322a-322c) formed in the valve block housing (301);
a first fluid conduit (431) coupled to each of the pressurized gas port (322a-322c), the first fluid conduit (431) having a longitudinal axis (535) substantially parallel to the longitudinal axis (324) of the stretch rod (303);
a second fluid conduit (432) coupled to the first fluid conduit (431) and to the stretch rod bore (304), the second fluid conduit (432) having a longitudinal axis (434) substantially perpendicular to the longitudinal axis of the stretch rod (303) and to the longitudinal axis (535) of the first fluid conduit (431); and
a valve (302a) coupled to the second fluid conduit (432) and adapted to selectively open a fluid flow path between the first fluid conduit (431) and the second fluid conduit (432).

8. The valve block assembly (300) of claim 7, wherein the valve (302a) comprises a valve piston (323) movable along a longitudinal axis (325) that is substantially parallel to the longitudinal axis (324) of the stretch rod (303).

9. The valve block assembly (300) of claim 7, wherein the fluid flow path (580) comprises only two changes in direction with a first change in direction proximate the coupling between the first fluid conduit (431) and the second fluid conduit (432) and a second change in direction proximate the coupling between the second fluid conduit (432) and the stretch rod bore (304).

10. The valve block assembly (300) of claim 7, further comprising a valve seat (430) formed in the second fluid conduit (432) and adapted to form a fluid tight seal with the valve piston (323).

11. The valve block assembly (300) of claim 7, further comprising a fluid passageway (560) between the stretch rod (303) and the stretch rod bore (304).

12. A valve block assembly (300), comprising:
two or more valve housing portion (301a-301d) coupled together to form a valve block housing (301);
a stretch rod bore (304) formed in the two or more valve housing portions (301a-301d);
a stretch rod (303) movable along a longitudinal axis (324) within the stretch rod bore (304);
one or more fluid flow paths (580) with each fluid flow path being defined by:
a fluid port (322a-322c) formed in a first valve housing portion (301a);
a first fluid channel portion (631a) formed in the first valve housing portion (301a) and in fluid communication with the fluid port (322a-322c), the first fluid channel portion (631a) having a longitudinal axis (635) substantially parallel to the longitudinal axis (324) of the stretch rod (303);
a second fluid channel portion (631b) formed in the first valve housing portion (301a) and a second valve housing portion (301b) such that the first and second fluid channel portions (631a, 631b) intersect one another and wherein the second fluid channel portion (631b) is in fluid communication with the first fluid channel portion (631a) and the stretch rod bore (304), the second fluid channel portion (631b) having a longitudinal axis (634) substantially perpendicular to the longitudinal axis of the stretch rod (303) and to the longitudinal axis (635) of the first fluid channel portion (631a); and
a valve (302a) located in the second valve housing portion (301b) proximate the intersection of the first and second fluid channel portions (631a, 631b) and adapted to selectively open a fluid flow path between the first fluid channel portion (631a) and the second fluid channel portion (631b).

13. The valve block assembly (300) of claim 12, further comprising a first turn (591) proximate the intersection of the first fluid channel portion (631a) and the second fluid channel portion (631b) and comprising a chamfered corner (681) formed in the first valve housing portion (301a).

14. The valve block assembly (300) of claim 12, further comprising a second turn (592) between the second fluid channel portion (631b) and the stretch rod bore (304) defined by a chamfered corner (682) formed in the second valve housing portion (301b).

15. The valve block assembly (300) of claim 12, wherein the valve (302a) comprises a valve piston (323) movable along a longitudinal axis (325) that is substantially parallel to the longitudinal axis (324) of the stretch rod (303).

16. A method for forming a valve block assembly for a blow molding system, comprising the steps of:
positioning a stretch rod within a stretch rod bore formed in a valve block housing such that the stretch rod is movable along a longitudinal axis within the stretch rod bore; and
positioning one or more valves at least partially within the valve block housing with the one or more valves spaced away from the stretch rod such that a longitudinal axis of a valve piston of each of the one or more valves is substantially parallel to a longitudinal axis of the stretch rod.

17. The method of claim 16, further comprising the step of forming one or more fluid flow paths with each fluid flow path being formed by:
coupling a first fluid conduit to a port formed in the valve block housing;
coupling a second fluid conduit to the first fluid conduit and to the stretch rod bore; and
coupling a valve of the one or more valves to the second fluid conduit proximate the first fluid conduit.

18. The method of claim 17, wherein the first fluid conduit comprises a longitudinal axis that is substantially parallel to the longitudinal axis of the stretch rod and wherein the second fluid conduit comprises a longitudinal axis that is substantially perpendicular to the longitudinal axis of the stretch rod.

19. The method of claim 17, wherein the fluid flow path comprises only two changes in direction with a first change in direction proximate the coupling between the first fluid conduit and the second fluid conduit and a second change in direction proximate the coupling between the second fluid conduit and the stretch rod bore.

20. The method of claim 17, wherein the valve is coupled to the second fluid conduit such that a valve piston of the valve can engage a valve seat formed in the second fluid conduit.

21. The method of claim 16, wherein the valve block housing comprises two or more valve housing portions and wherein the method further comprises the step of forming one or more fluid flow paths with each fluid flow path being formed by:
forming a fluid port and a first fluid channel portion in fluid communication with the fluid port in a first valve housing portion;
forming a second fluid channel portion in the first valve portion and a second valve portion such that the second fluid channel portion intersects the first fluid channel portion and is in fluid communication with the first fluid channel portion and the stretch rod bore;
positioning a valve of the one or more valves in the second block housing portion proximate the intersection of the first and second fluid channel portions; and
coupling the first and second valve housing portions together.

22. The method of claim 21, wherein the fluid flow path comprises only two changes in direction with a first change in direction proximate the intersection of the first and second fluid channel portions and comprising a first chamfered corner and a second change in direction between the second fluid channel portion and the stretch rod bore and comprising a second chamfered corner.
